(19) United States
(12) Patent Application Publication
(10) Pub. No.: US 2016/0122100 A1
(43) Pub. Date: May 5, 2016

(54) PACKAGING MATERIALS AND METHODS FOR THEIR PREPARATION AND USE

(71) Applicant: EMPIRE TECHNOLOGY DEVELOPMENT LLC, Wilmington, DE (US)

(72) Inventors: Benjamin William MILLAR, Rosebery, New South Wales (AU); George Charles PEPPOU, Hornsby Heights, New South Wales (AU); Michael Keoni MANION, Cronulla, New South Wales (AU); Benjamin Watson BARNES, Thornleigh, New South Wales (AU)

(21) Appl. No.: 14/891,721

(22) PCT Filed: May 17, 2013
(86) PCT No.: PCT/US2013/041515

§ 371 Date: Nov. 17, 2015

(51) Int. Cl. B65D 65/40; B32B 27/32; B32B 27/30; B32B 27/36; B32B 37/06; B32B 27/08; B32B 7/02; B32B 3/30; B65D 81/38; B32B 3/02; B32B 27/34

(52) U.S. Cl. CPC B65D 65/40; B32B 3/02; B32B 27/32; B32B 27/304; B32B 27/36; B32B 27/365; B32B 27/34; B32B 27/08; B32B 7/02; B32B 3/30; B65D 81/38; B32B 37/06; B32B 2307/308; B32B 2439/00; B32B 2439/70; B32B 2553/02

(57) ABSTRACT

Packaging materials including at least one copolymer sheet containing a first polymer having a high coefficient of thermal expansion, and a second polymer having a low coefficient of thermal expansion are described. In some configurations, the copolymer sheet includes one or more sections of a bimorph structure having a first layer of the first polymer and a second layer of the second polymer. Methods of making a packaging material by bonding the first layer and the second layer to form a copolymer sheet; and heating the copolymer sheet at discrete sections to destroy the layer definition forming discrete sections having a bimorph structure of the first layer and the second layer are also described, as are kits useful for preparing the packaging material.

### BACKGROUND

Goods that typically employ thin film packaging or rely on shelf packaging, but which require product integrity and consistency would benefit from increased insulation from temperature changes. Most forms of confectionary and other food items are temperature sensitive, and yet are sold in inexpensive, low bulk packaging due to their low unit cost and reliance on packaging for sales. Likewise, any minimally packaged refrigerated or cooled food item that is transported between cold storage locations or not immediately refrigerated by customers upon purchasing would benefit from better insulation.

Current methods for producing packaging expansion in response to temperature change typically rely on phase change blowing agents or expensive, complex shape memory materials. There is a need for dynamic insulation made from low cost and simple manufacturing techniques. Such insulation would need to provide protection from positive or negative temperature fluctuations, whilst allowing rapid response of the insulation to the temperature fluctuations. Further, there is a need for methods of producing such thermally expanding films.

### SUMMARY

In some embodiments, a packaging material may include at least one copolymer sheet containing a first polymer having a high coefficient of thermal expansion, and a second polymer having a low coefficient of thermal expansion. The copolymer sheet may include one or more sections of a bimorph structure having a first layer of the first polymer and a second layer of the second polymer.

In some embodiments, a method of making a packaging material may include bonding a first layer including a first polymer having a high coefficient of thermal expansion, to a second layer including a second polymer having a low coefficient of thermal expansion, to form at least one copolymer sheet; and heating the at least one copolymer sheet at one or more discrete sections to form one or more sections of a bimorph structure in the copolymer sheet. The bimorph structure may include a first layer of the first polymer and a second layer of the second polymer.

In some embodiments, a kit for preparing a packaging material may include at least one copolymer sheet including a first polymer having a high coefficient of thermal expansion, and a second polymer having a low coefficient of thermal expansion; and instructions for use of the at least one copolymer sheet. The at least one copolymer sheet may include one or more sections of a bimorph structure including a first layer of the first polymer and a second layer of the second polymer.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIGS. 1A-1C illustrate various copolymer sheets in accordance with embodiments described herein. FIG. 1A illustrates a bonded copolymer sheet according to an embodiment; FIG. 1B illustrates a copolymer sheet having discrete bimorph sections according to an embodiment; and FIG. 1C illustrates a colpolymer sheet under thermal stress according to an embodiment.

FIG. 2 illustrates multiple copolymer sheets of the packaging material in accordance with embodiments described herein, discretely bonded and stacked, at neutral temperature.

FIG. 3 illustrates multiple copolymer sheets of the packaging material in accordance with embodiments described herein, discretely bonded and stacked, at a temperature elevated above the neutral temperature.

FIG. 4 illustrates two possible two-dimensional layouts of the copolymer sheets of embodiments described herein and their corresponding multilayered structure: perpendicular (FIG. 4A) and parallel (FIG. 4B).

FIG. 5 illustrates an exemplary roll formation of a packaging material having a parallel orientation according to embodiments described herein.

### DETAILED DESCRIPTION

In the following detailed description, reference is made to the accompanying drawings, which form a part of this document. In the drawings, similar symbols typically identify similar components, unless the context dictates otherwise. The illustrative embodiments described in the detailed description, drawings, and claims are not meant to be limiting. Other embodiments may be used, and other changes may be made, without departing from the spirit or scope of the subject matter presented in this document. It will be readily understood that the aspects of the present disclosure, as generally described in this document, and illustrated in the Figures, can be arranged, substituted, combined, separated, and designed in a wide variety of different configurations, all of which are explicitly contemplated to be within the scope of this disclosure.

Embodiments described herein are directed to a polymer packaging material that responds to temperature changes from a predetermined neutral temperature by significantly expanding its thickness. As used herein, a neutral temperature refers to a temperature at which the packaging material has no strain between its bimorph layers (that is the bimorph sections of the packaging material are essentially flat and has little or no actuation). Typically, the neutral temperature may be the temperature and shape at which the sheet was formed. In some embodiments, the packaging material actuates at temperatures above the neutral temperature. In some embodiments, the packaging material actuates at temperatures below the neutral temperature.

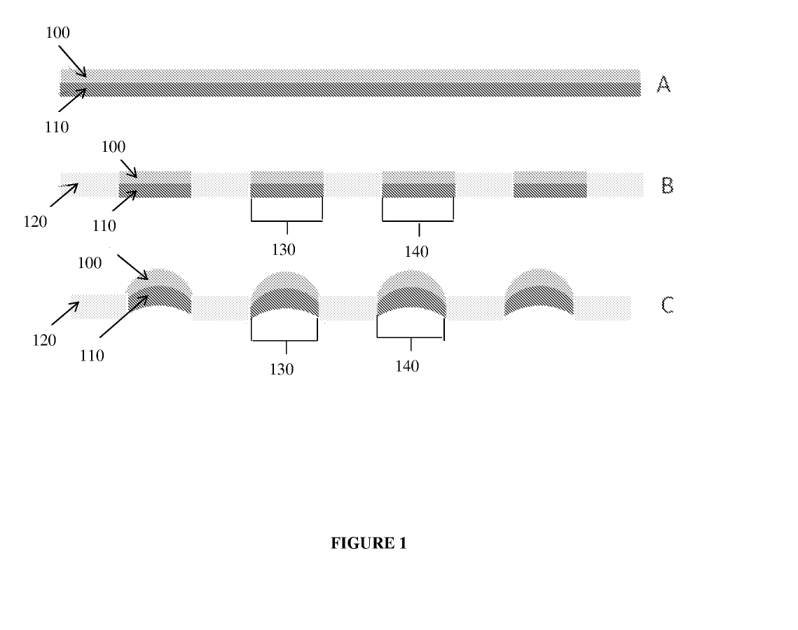

The polymer packaging material may, for example, be a multilayer polymer packaging material. As shown in FIG. 1B, in some embodiments, the packaging material may include at least one copolymer sheet 120 including a first polymer 100 having a high coefficient of thermal expansion and a second polymer 110 having a low coefficient of thermal expansion. In some embodiments, the copolymer sheet includes one or more sections of a bimorph structure 130 including a first layer of the first polymer 100 and a second layer of the second polymer 110. In some embodiments, the copolymer sheet includes one or more sections of a homogenous region 140 where the delineation between the two polymers of the bimorph structure has been eliminated to create a copolymer.

In some embodiments, expanding the thickness of the packaging material increases insulation. This may be achieved using properties intrinsic to the disclosed polymers and does not require adding of phase change agents. Fabrication may be performed using standard continuous processing techniques and existing food packaging polymers. Further technical modifications such as, for example, cross-linking, use of copolymers, or use of high grade technical polymers, may be made to the packaging materials or methods described herein.

Significant improvement of insulation properties may be achieved when a packaging film subjected to temperature variation takes advantage of the wide range of polymeric Coefficient of Thermal Expansions (CTEs). As shown in FIGS. 1A-1C, bimorph strips of two bonded materials with different CTEs follow the principles of thermal actuation. The different thermal expansions of the bonded materials may cause the strip to bend when heated and revert to its original shape when cooled to a neutral temperature. A similar flex may occur when cooled below the neutral temperature.

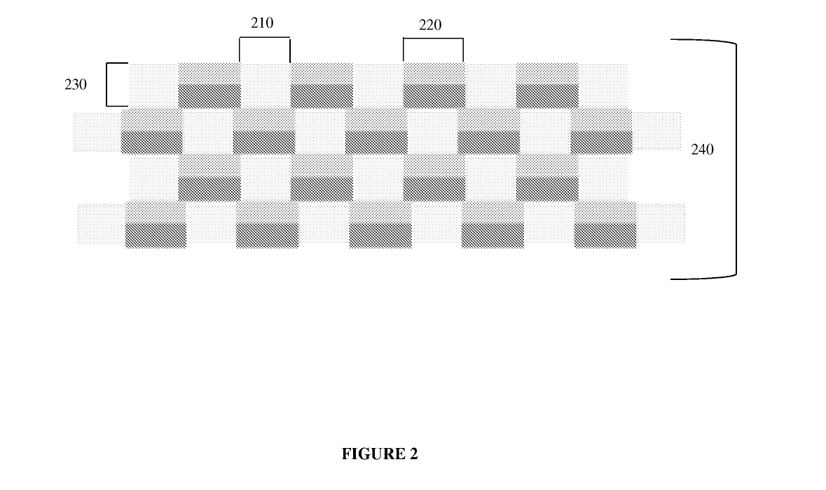

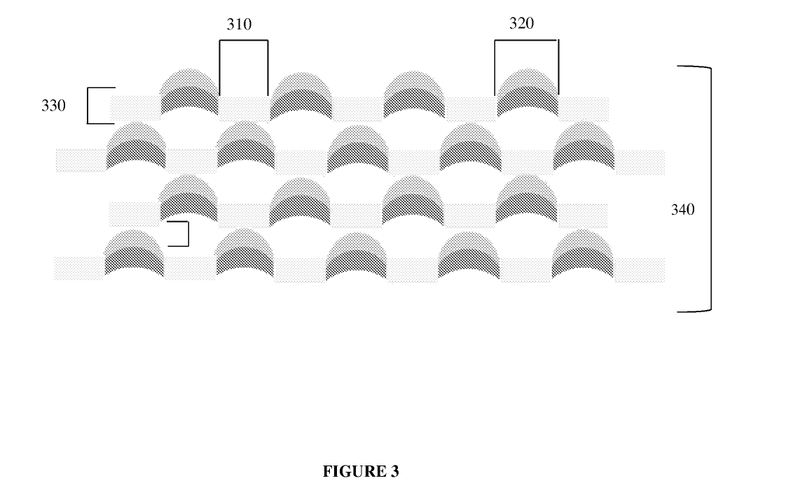

A substantial variation in thermal insulation properties may be achievable using the packaging materials of embodiments described herein. FIGS. 2 and 3 illustrate the action of the final active form of a packaging material that includes multiple layers of copolymer sheet. FIG. 2 illustrates the multiple layers of copolymer sheet 230 at neutral temperature, and FIG. 3 illustrates the appearance of a thermally actuated form of the multiple layers of copolymer sheet 330, i.e. when exposed to a temperature above the neutral temperature. At above the neutral temperature, there may be a substantial increase in thickness of the multiple layers of the copolymer sheet 330 and enclosed free space 350 within the packaging material 340.

As shown in FIG. 2, bonding between the copolymer sheets 230 may be formed between a midpoint of a bimorph region 220 of a lower sheet and a midpoint of a homogenous region 210 of an upper sheet in the packaging material 240. As shown in FIG. 3, during thermal actuation, different thermal expansions of bonded materials within the copolymer sheet 330 may cause the bimorph regions 320 of the sheets 330 to bend, and to thereby result in pockets of free space 350 between the multiple layers of copolymer sheets 330. As the sheets 330 may contract slightly across their longitudinal planes during thermal actuation, slightly loose packaging, edge folds, or a suitably elastic edge material may be used to minimize unnecessary stresses on the packaging material.

In some embodiments, the packaging material is thermostable. As used herein, the term “thermostable” refers to the quality of the packaging material to resist irreversible change in its chemical or physical structure due to changes in temperature. In some embodiments, the packaging material is stable at a temperature of about −50° C. to about 65° C. For example, the packaging material is stable at a temperature of about −50° C. to about 45° C., about −50° C. to about 25° C., about −30° C. to about 65° C., about −30° C. to about 45° C., about −30° C. to about 25° C., about −10° C. to about 65° C., about −10° C. to about 45° C., about −10° C. to about 25° C., or a combination thereof. In some embodiments, the packaging material is stable at a temperature of about −10° C., about −5° C., about 0° C., about 10° C., about 20° C., about 30° C., about 45° C., about 50° C., about 65° C., or a range between any two of these values.

The actuation curvature of the packaging materials according to embodiments described herein may be strongly influenced by layer thickness of the copolymer sheet. For example, a thinner layer of copolymer sheet may produce a greater curvature. In some embodiments, the at least one copolymer sheet has a thickness of about 20 μm to about 2 mm For example, the at least one copolymer sheet has a thickness of about 20 μm to about 1.5 mm, about 20 μm to about 1 mm, about 20 μm to about 500 μm, about 20 μm to about 400 μm, about 20 μm to about 300 μm, about 20 μm to about 200 μm, or a combination thereof. In some embodiments, the at least one copolymer sheet has a thickness of about 20 μm, about 40 μm, about 60 μm, about 80 μm, about 100 μm, about 125 μm, about 150 μm, about 175 μm, about 200 μm, about 400 μm, about 600 μm, about 800 μm, about 1 mm, about 1.5 mm, about 2 mm, or a range between any two of these values.

In some embodiments, the first layer and second layer of the copolymer sheet according to embodiments described herein are formed at sub-millimeter thicknesses. In some embodiments, the first layer of the first polymer has a thickness of about 10 μm to about 1 mm. For example, the first layer of the first polymer as a thickness of about 10 μm to about 750 μm, about 10 μm to about 500 μm, about 10 μm to about 250 μm, about 10 μm to about 100 μm, or a combination thereof. In some embodiments, the first layer of the first polymer has a thickness of about 10 μm, about 20 μm, about 30 μm, about 40 μm, about 50 μm, about 60 μm, about 70 μm, about 80 μm, about 90 μm, about 100 μm, about 200 μm, about 400 μm, about 600 μm, about 800 μm, about 1 mm, or a range between any two of these values.

In some embodiments, the first polymer is selected from linear low density polyethylene, high density polyethylene, ultra-high molecular weight polyethylene, polyoxymethylene (Acetal), polyvinylidene fluoride (PVDF), or a combination thereof. In some embodiments, the first polymer has a high coefficient of thermal expansion. In some embodiments, the first polymer has a coefficient of thermal expansion of at least about 70 μm/mK. In some embodiments, the first polymer has a coefficient of thermal expansion of about 70 μm/mK to about 250 μm/mK, 90 μm/mK to about 250 μm/mK, 110 μm/mK to about 250 μm/mK, 150 μm/mK to about 250 μm/mK, or a combination thereof. In some embodiments, the first polymer has a coefficient of thermal expansion of about 70 μm/mK, 90 μm/mK, 110 μm/mK, 130 μm/mK, 150 μm/mK, 170 μm/mK, 200 μm/mK, 220 μm/mK, 250 μm/mK, or a range between any two of these values.

In some embodiments, the second layer of the second polymer has a thickness of about 10 μm to about 1 mm For example, the second layer of the second polymer can have a thickness of about 10 μm to about 750 μm, about 10 μm to about 500 μm, about 10 μm to about 250 μm, about 10 μm to about 100 μm, or a combination thereof. In some embodiments, the second layer of the second polymer can have a thickness of about 10 μm, about 20 μm, about 30 μm, about 40 μm, about 50 μm, about 60 μm, about 70 μm, about 80 μm, about 90 μm, about 100 μm, about 200 μm, about 400 μm, about 600 μm, about 800 μm, about 1 mm, or a range between any two of these values.

In some embodiments, the second polymer is selected from polyethylene terephthalate, nylon, polycarbonate, polyetheretherketone (PEEK), polyimide, polyetherimide, or a combination thereof. In some embodiments, the second polymer has a low coefficient of thermal expansion. In some embodiments, the second polymer has a coefficient of thermal expansion equal to or less than about 80 μm/mK. In some embodiments, the second polymer has a coefficient of thermal expansion of about 10 μm/mK to about 80 μm/mK, about 10 μm/mK to about 70 μm/mK, about 10 μm/mK to about 50 μm/mK, about 10 μm/mK to about 40 μm/mK, about 10 μm/mK to about 30 μm/mK, about 10 μm/mK to about 20 μm/mK, or a combination thereof. In some embodiments, the second polymer has a coefficient of thermal expansion of about 10 μm/mK, about 20 μm/mK, about 30 μm/mK, about 40 μm/mK, about 50 μm/mK, about 60 μm/mK, about 70 μm/mK, about 80 μm/mK, or a range between any two of these values.

In some embodiments, the packaging material is flexible. In some embodiments, the flexural modulus of the copolymer sheet may be similar to existing flexible packaging materials. The flexural modulus is a function of the shape of the copolymer sheet (i.e the thickness and area) and the intrinsic property of material's elasticity (elastic modulus). In some embodiments, the at least one copolymer sheet includes a plurality of copolymer sheets. In some embodiments, the plurality of copolymer sheets are bonded together to form a multilayer sheet. In some embodiments, the one or more sections of the bimorph structure of a first copolymer sheet in the multilayer sheet are bonded to one or more copolymer sections of a second copolymer sheet in the multilayer sheet.

In some embodiments, the at least one copolymer sheet includes a series of bimorph sections. In some embodiments, the one or more sections of the bimorph structure in the copolymer sheet have a width of about 2 mm to about 20 mm For example, the one or more sections of the bimorph structure have a width of about 2 mm to about 50 mm, about 2 mm to about 40 mm, about 2 mm to about 30 mm, about 2 mm to about 10 mm, about 2.5 mm to about 50 mm, about 2.5 mm to about 40 mm, about 2.5 mm to about 30 mm, about 2.5 mm to about 20 mm, about 2.5 mm to about 10 mm, about 1.5 mm to about 50 mm, about 1.5 mm to about 40 mm, about 1.5 mm to about 30 mm, about 1 5 mm to about 20 mm, or a combination thereof. In some embodiments, the one or more sections of the bimorph structure in the copolymer sheet have a width of about 1.5 mm, about 2 mm, about 2.5 mm, about 3 mm, about 5 mm, about 7 mm, about 10 mm, about 15 mm, about 20 mm, or a range between any two of these values.

In some embodiments, after deformation, for example by thermal actuation, the one or more sections of the biomorph structure in the copolymer sheet are adapted to reduce a width of the one or more sections of the biomorph structure by up to about 10% to about 75%. For example, the reduction in width of the one or more sections of the bimorph structure after deformation can be up to about 50%, up to about 30%, up to about 25%, up to about 20%, up to about 15%, up to about 10%, about 10%, about 20%, about 25%, about 30%, about 50%, about 75%, or a range between any two of these values.

In some embodiments, the one or more sections of the bimorph structure in the copolymer sheet have a thickness of about 20 μm to about 10 mm For example, the one or more sections of the bimorph structure in the copolymer sheet have a thickness of about 20 μm to about 5 mm, about 20 μm to about 3 mm, about 20 μm to about 1 mm, about 20 μm to about 500 μm, about 30 μm to about 5 mm, about 30 μm to about 3 mm, about 30 μm to about 1 mm, about 30 μm to about 500 μm, about 40 μm to about 5 mm, about 40 μm to about 3 mm, about 40 μm to about 1 mm, about 40 μm to about 500 μm, about 50 μm to about 5 mm, about 50 μm to about 3 mm, about 50 μm to about 1 mm, about 50 μm to about 500 μm, or a combination thereof. In some embodiments, the one or more sections of the bimorph structure in the copolymer sheet have a thickness of about 50 μm, about 100 μm, about 200 μm, about 300 μm, about 40 μm, about 500 μm, about 1 mm, about 5 mm, about 10 mm, or a range between any two of these values.

In some embodiments, the one or more sections of the bimorph structure in the copolymer sheet are adapted to increase in thickness by up to about 300% to about 5500%. For example, the increase in thickness of the one or more sections of the bimorph structure can be up to about 5500%, up to about 5000%, up to about 3000% up to about 2000%, up to about 1000%, up to about 500%, or up to about 300%, after deformation. In some embodiments, after deformation, the thickness of the bimorph structure is increased by about 5500%, about 5000%, about 3000%, about 2000%, about 1000%, about 500%, about 300%, or a range between any two of these values.

In some embodiments, the thickness of the one or more sections of the bimorph structure of the copolymer sheet, after deformation, is about 100 μm to about 30 mm. For example, the thickness of the one or more sections of the bimorph structure of the copolymer sheet, after deformation, is about 100 μm to about 25 mm, about 100 μm to about 20 mm, about 100 μm to about 15 mm, about 100 μm to about 10 mm, about 500 μm to about 30 mm, about 500 μm to about 25 mm, about 500 μm to about 20 mm, about 500 μm to about 15 mm, about 500 μm to about 10 mm, or a combination thereof. In some embodiments, the thickness of the one or more sections of the bimorph structure of the copolymer sheet, after deformation, is about 100 μm, about 300 μm, about 500 μm, about 10 mm, about 20 mm, about 30 mm, or a range between any two of these values. For example, in some embodiments, a packaging material having six bimorph sheets of 40 μm thickness each (with a total thickness of 240 μm) before deformation may expand to a thickness of about 12 mm after deformation. In some embodiments, the expansion and increase in thickness of the bimorph sections of the copolymer sheet may be dependent on the amount of temperature change. In general, the larger the temperature change the greater the increase in expansion of the one or more sections of the bimorph structure in the copolymer sheet. The ratio of expansion to temperature change may be controlled by the shape (that is, the thickness, width and length) of each expanding area and the polymer layers comprising the packaging material, and the material properties (CTE and elastic modulus) of the polymers used.

In some embodiments, the one or more sections of the bimorph structure in the copolymer sheet are adapted to undergo deformation to create one or more pockets at a temperature above a neutral temperature. In some embodiments, the one or more sections of the bimorph structure in the copolymer sheet are adapted to reverse the deformation at or below the neutral temperature.

In some embodiments, the neutral temperature is about −20° C. to about 20° C. For example, the neutral temperature is about −20° C. to about 15° C., about −20° C. to about 10° C., about −20° C. to about 5° C., about −20° C. to about 0° C., about −18° C. to about 20° C., about −18° C. to about 15° C., about −18° C. to about 10° C., about −18° C. to about 5° C., about −18° C. to about 0° C., or a combination thereof. In some embodiments, the neutral temperature is about −20° C., about −10° C., about −5° C., about 0° C., about 5° C., about 10° C., about 15° C., about 18° C., about 20° C., or a range between any two of these values. Neutral temperature may be determined during manufacturing and selected according to the requirements of the product to be packaged. At the neutral temperature, the length and width of the polymer having a high CTE and the polymer having a low CTE in each bimorph section are equal, thus there is no strain, and no lifting from the plane (expansion). In some embodiments, the neutral temperature may be set by controlling ambient heat, stretching the copolymer sheet, or a combination thereof. For example, the neutral temperature may be set by sizing the separate homogeneous polymer films (that is, the polymer having a high CTE and the polymer having the low CTE) at the designated ambient neutral temperature before bonding and copolymer formation. This may ensure that at the designated temperature both polymers will be the same size, thereby eliminating strain.

As shown in FIG. 1A, in some embodiments, a method of making the packaging materials according to embodiments described herein may include forming a copolymer polymer sheet 120 including bonding a layer of a first polymer 100 having a high coefficient of thermal expansion (CTE) and a layer of a second polymer 110 having a low CTE polymer. The resulting bilayer sheet may be heated at discrete periodic points to form a copolymer sheet 120 and destroy the layer definition at these points (FIG. 1B). When the sheet 120 is exposed to thermal stress (that is, variation in temperature from a set neutral point), the sections of the sheet 120 with bimorph structures 130 may deform (FIG. 1C), creating gas pockets and improving the thermal insulation properties of the sheet.

Some embodiments described herein are directed to a method of making a packaging material may include bonding a first layer including a first polymer having a high coefficient of thermal expansion to a second layer including a second polymer having a low coefficient of thermal expansion to form at least one copolymer sheet; and heating the at least one copolymer sheet at one or more discrete sections to form one or more sections of a bimorph structure in the copolymer sheet. The bimorph structure may include a first layer of the first polymer and a second layer of the second polymer. The method may further include adding a printed layer to the outer surface of the multilayer sheet for product appearance.

In some embodiments, bonding the first layer to the second layer to form the copolymer sheet may be carried out using existing techniques for bilayer formation. In some embodiments, bonding the first layer to the second layer includes low power spot bonding, line bonding, ultrasonic welding, solvent bonding, adhesive bonding, point thermal bonding, polymer or metallic micro-rivets, or a combination thereof.

In some embodiments, the bonded first layer and second layer of the polymers may be thermally bonded indiscriminately at a few locations across the total area of the bilayer sheet to create a copolymer sheet. In some embodiments, the bimorph effect is eliminated at the bonded areas creating copolymer regions. In some embodiments, a quilting pattern allows the packaging material to function effectively. In this method, not every bimorph expansion point is bonded to the sheet above it, some are left unbonded yet they remain in the same position. The copolymer sheets may be bonded at large bond points or by linear thermal bonds at regular intervals across the packaging material. These large bond points may not possess expansion capabilities themselves. Because such copolymer sheets are not laminated between such bonds, more air may be trapped, thereby increasing thermal insulation. This method may simplify manufacture without damage to the performance of the packaging material.

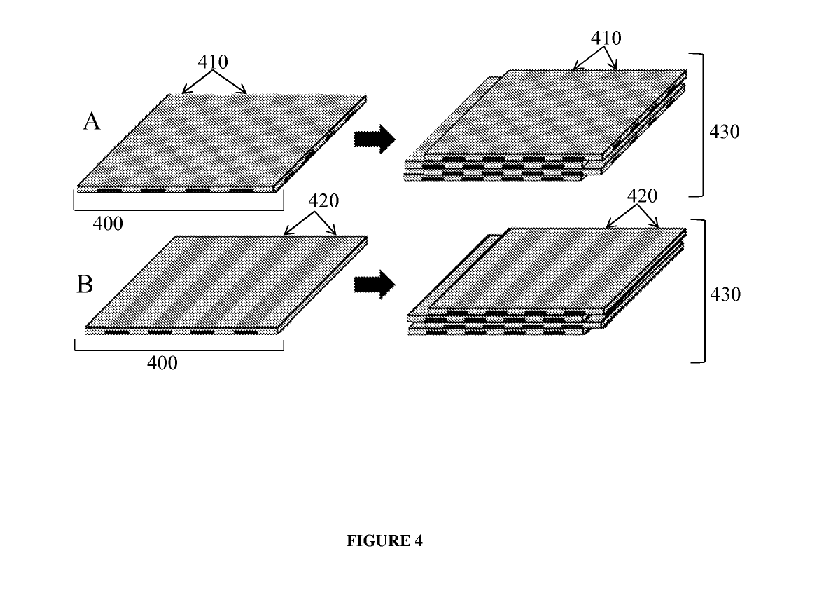

In some embodiments, as shown in FIG. 4, the bimorph regions may be formed in a number of two dimensional patterns: forming discrete segments 410 (FIG. 4A), or elongated regions 420 (FIG. 4B). Other patterns may be possible. The copolymer sheets 400 may then be layered accordingly to form a multilayer sheet 440.

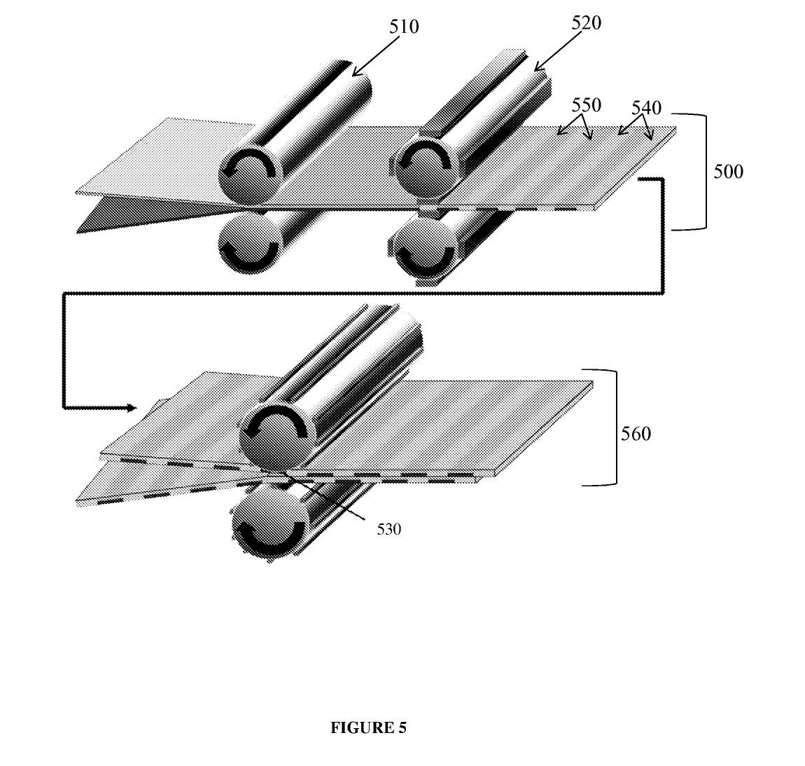

In some embodiments, heating the copolymer sheet at one or more discrete sections includes heating the copolymer sheet using heated roller embossing techniques. FIG. 5 illustrates an example of roll formation according to an embodiment of the packaging material. In some embodiments, heating the copolymer sheet at one or more discrete sections may be carried out in a perpendicular orientation or using different shaped presses for different patterns. As shown in FIG. 5, for example, a roller 510 may be used to bond the first polymer having a high coefficient of thermal expansion and the second polymer having a low coefficient of thermal expansion. Following such bonding, a roll press 520 may be used to create elongated regions of copolymer 540 by thermally bonding elongated regions across the total area of the bilayer sheet to create a copolymer sheet 500 having elongated regions of copolymer 540 and elongated regions of the bimorph structure 550. An additional roll press 530 may be used to bond the copolymer sheets 500 together to form a multilayered sheet 560.

In some embodiments, making a packaging material may further include thermally stressing the copolymer sheet to deform the one or more sections of bimorph structure. In some embodiments, thermally stressing the copolymer sheet creates one or more pockets in the copolymer sheet. In some embodiments, the expansion of the bimorph sections is reversible.

In some embodiments, the method further includes subjecting the one of more sections of the bimorph structure to deformation to create one or more pockets in response to exposure of the copolymer sheet to a temperature above a neutral temperature. In some embodiments, the one or more sections of the bimorph structure in the copolymer sheet are adapted to reverse the deformation at or below the neutral temperature. In some embodiments, the method further includes setting the neutral temperature by controlling ambient heat, stretching the copolymer sheet, or a combination thereof. In some embodiments, the multiple layers of the copolymer sheet may be laminated and point bonded to form a strong, variable thickness barrier.

In some embodiments, the method further includes bonding a plurality of copolymer sheets to each other to form a multilayer sheet. Bonding the plurality of copolymer sheets may include low power spot bonding, line bonding, ultrasonic welding, solvent bonding, adhesive bonding, point thermal bonding, or a combination thereof. In some embodiments, bonding the plurality of copolymer sheets includes bonding the one or more sections of the bimorph structure of a first copolymer sheet in the multilayer sheet to one or more copolymer sections of a second copolymer sheet in the multilayer sheet.

Some embodiments are directed to a kit for preparing a packaging material having at least one copolymer sheet including a first polymer having a high coefficient of thermal expansion, and a second polymer having a low coefficient of thermal expansion; and instructions for use of the at least one copolymer sheet. The at least one copolymer sheet may include one or more sections of a bimorph structure including a first layer of the first polymer and a second layer of the second polymer.

Packaging materials of the embodiments described herein may be used, for example, for food packaging, including confectionary, cooled or refrigerated food, or the like. In such situations, the packaging further includes food or beverages disposed within the packaging. Other materials may similarly be disposed within the packaging, such as pharmaceuticals, cosmetics, logistics and the like. Such packaging materials may provide a low cost, low bulk method of insulating confectionary. Such packaging materials may also be applied to any minimally packaged refrigerated or cooled food item that is to be transported between cold storage locations or not immediately refrigerated by customers upon purchasing. Additionally, the packaging materials of embodiments herein may be applied to any goods that typically employ thin film packaging or rely on shelf packaging appearance, and/or for which product integrity and consistency may benefit from increased insulation. Thinner film thicknesses can produce greater expansions but at increasingly low actuation force. Similarly, as thicker films are employed actuation force becomes greater, but expansion displacement may be reduced.

### EXAMPLES

### Example 1

A packaging material having five bonded layers of a copolymer sheet having a high density polyethylene layer bonded to a polyethylene terephthalate layer.

A packaging material includes five bonded copolymer sheets. Each copolymer sheet includes a first polymer layer and a second polymer layer. The first polymer layer is high density polyethylene and has a coefficient of thermal expansion of about 120 μm/mK. The second polymer layer is polyethylene terephthalate and has a low coefficient of thermal expansion of about 50 μm/mK. The first and second polymer layers have a thickness of 40 μm each resulting in a total thickness of 80 μm for each copolymer sheet and 400 μm for the five bonded copolymer sheets. Bimorph sections are formed in the copolymer sheets, each having a width of 12 mm. The neutral temperature is set at 10° C. during preparation of the packaging material by sizing the separate polymer layers (that is, the high density polyethylene and polyethylene terephthalate) at the designated ambient neutral temperature of 10° C. before bonding and copolymer formation. In response to a 15° C. increase in temperature, the thickness of the bimorph sections is expected to expand to 2.04 mm, a 510% increase from the initial thickness of 400 μm.

### Example 2

A packaging material having six bonded layers of a copolymer sheet each having a linear low density polyethylene layer bonded to a nylon layer.

A packaging material includes six bonded copolymer sheets. Each copolymer sheet includes a first polymer layer and a second polymer layer. The first polymer layer is linear low density polyethylene and has a high coefficient of thermal expansion of about 220 μm/mK. The second polymer layer is nylon and has a low coefficient of thermal expansion of about 70 μm/mK. The first and second polymer layers have a thickness of 40 μm each resulting in a total thickness of 80 μm for each copolymer sheet and 480 μm for the six bonded copolymer sheets. Bimorph sections are formed in the copolymer sheets, each having a width of 10 mm. The neutral temperature is set at 5° C. during preparation of the packaging material by sizing the separate polymer layers (that is, the linear low density polyethylene and nylon) at the designated ambient neutral temperature of 5° C. before bonding and copolymer formation. In response to a 5° C. increase in temperature, the thickness of the bimorph sections is expected to expand to 1.88 mm, a 393% increase from the initial thickness of 480 μm.

### Example 3

A method of preparing a packaging material having five bonded copolymer sheets each having an ultra-high molecular weight polyethylene layer bonded to a polycarbonate layer.

A packaging material is prepared by adhesively bonding an ultra-high molecular weight polyethylene layer to a polycarbonate layer to form a copolymer sheet having a thickness of about 50 μm. The copolymer sheet is thermally bonded at several discrete sections to destroy the layer definition at these points and form 15 mm wide sections having a bimorph structure in the copolymer sheet. The bimorph regions form a two dimensional pattern of discrete sections. A multilayer sheet is made by low power spot bonding the sections of bimorph structure of a first copolymer sheet to the copolymer sections of a second copolymer sheet, such that five copolymer sheets are bonded together in the multilayer sheet. The multilayer sheet has a thickness of about 250 μm. A printed layer is added to an outer surface of the multilayer sheet for product appearance.

### Example 4

A packaging material containing a food item, the packaging material having six bonded layers of a copolymer sheet each having a polyvinylidene fluoride layer bonded to a polycarbonate layer.

A packaging material having a piece of chocolate enclosed within includes six bonded copolymer sheets. Each copolymer sheet includes a first polymer layer and a second polymer layer. The first polymer layer is polyvinylidene fluoride and has a high coefficient of thermal expansion of about 120 μm/mK. The second polymer layer is polycarbonate and has a low coefficient of thermal expansion of about 60 μm/mK. The first and second polymer layers have a thickness of 40 μm each resulting in a total thickness of 80 μm for each copolymer sheet and 480 μm for the six bonded copolymer sheets. Bimorph sections are formed in the copolymer sheets, each having a width of 10 mm. The neutral temperature is set at 5° C. during preparation of the packaging material by sizing the separate polymer layers (that is, the polyvinylidene fluoride and polycarbonate) at the designated ambient neutral temperature of 5° C. before bonding and copolymer formation. In response to a 5° C. increase in temperature, that is, an increase from 25° C. to 30° C. the thickness of the bimorph sections is expected to expand to 1 mm providing temperature insulation and protecting the piece of chocolate. Due to the insulation from the temperature increase provided by the packaging material, it is expected that the chocolate will not melt and deform. The chocolate also will not exhibit an unappealing white surface “bloom”, indicative of undesired heating.

The present disclosure is not to be limited in terms of the particular embodiments described in this application, which are intended as illustrations of various aspects. Many modifications and variations can be made without departing from its spirit and scope, as will be apparent to those skilled in the art. Functionally, equivalent methods and apparatuses within the scope of the disclosure, in addition to those enumerated in this document, will be apparent to those skilled in the art from the foregoing descriptions. Such modifications and variations are intended to fall within the scope of the appended claims. The present disclosure includes the full scope of equivalents to which the claims are entitled. It is to be understood that this disclosure is not limited to particular methods, reagents, compounds, compositions or biological systems, which can, of course, vary. It is also to be understood that the terminology used in this document is for the purpose of describing particular embodiments only, and is not intended to be limiting.

With respect to the use of substantially any plural and/or singular terms in this document, those having skill in the art can translate from the plural to the singular and/or from the singular to the plural as is appropriate to the context and/or application. The various singular/plural permutations may be expressly set forth in this document for sake of clarity.

It will be understood by those within the art that, in general, terms used in this document, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed in this document also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed in this document can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 bonds refers to groups having 1, 2, or 3 bonds. Similarly, a group having 1-5 bonds refers to groups having 1, 2, 3, 4, or 5 bonds, and so forth.

From the foregoing, it will be appreciated that various embodiments of the present disclosure have been described in this document for purposes of illustration, and that various modifications may be made without departing from the scope and spirit of the present disclosure. Accordingly, the various embodiments disclosed in this document are not intended to be limiting, with the true scope and spirit being indicated by the following claims.

1. A packaging material comprising:
at least one copolymer sheet comprising a first polymer having a high coefficient of thermal expansion and a second polymer having a low coefficient of thermal expansion;
wherein the copolymer sheet includes one or more sections of a bimorph structure comprising a first layer of the first polymer and a second layer of the second polymer.

2. The packaging material of claim 1, wherein the packaging material is thermostable.

3. (canceled)

4. The packaging material of claim 1, wherein the first layer has and the second layer each independently have a thickness of about 10 μm to about 1 mm.

5.-6. (canceled)

7. The packaging material of claim 1, wherein the first polymer is selected from linear low density polyethylene, high density polyethylene, ultra-high molecular weight polyethylene, polyoxymethylene (Acetal), Polyvinylidene fluoride (PVDF), or a combination thereof.

8. The packaging material of claim 1, wherein the second polymer is selected from polyethylene terephthalate, nylon, polycarbonate, polyether ether ketone (PEEK), polyimide, polyetherimide, or a combination thereof.

9.-11. (canceled)

12. The packaging material of claim 1, wherein the one or more sections of the bimorph structure in the copolymer sheet have a width of about 2 mm to about 20 mm and a thickness of about 20 μm to about 10 mm.

13. (canceled)

14. The packaging material of claim 1, wherein the one or more sections of the bimorph structure in the copolymer sheet are adapted to undergo deformation to create one or more pockets at a temperature above a neutral temperature.

15. (canceled)

16. The packaging material of claim 14, wherein the neutral temperature is about −20° C. to about 20° C.

17. The packaging material of claim 14, wherein the one or more sections of the bimorph structure in the copolymer sheet are adapted to reduce a width of the one or more sections of the bimorph structure by up to about 20% after deformation.

18. The packaging material of claim 14, wherein the one or more sections of the bimorph structure in the copolymer sheet are adapted to increase a thickness of the one or more sections of the bimorph structure by up to about 5500% after deformation.

19. The packaging material of claim 18, wherein the thickness of the one or more sections of the bimorph structure of the copolymer sheet after deformation is about 100 μm to about 30 mm.

20. A method of making a packaging material, the method comprising:
bonding a first layer comprising a first polymer having a high coefficient of thermal expansion to a second layer comprising a second polymer having a low coefficient of thermal expansion to form at least one copolymer sheet; and
heating the at least one copolymer sheet at one or more discrete sections to form one or more sections of a bimorph structure in the copolymer sheet, wherein the bimorph structure comprises a first layer of the first polymer and a second layer of the second polymer.

21.-22. (canceled)

23. The method of claim 20, further comprising thermally stressing the copolymer sheet to deform the one or more sections of bimorph structure.

24.-25. (canceled)

26. The method of claim 25, further comprising bonding the plurality of copolymer sheets to each other to form a multilayer sheet.

27. (canceled)

28. The method of claim 26, wherein bonding the plurality of copolymer sheets comprises bonding the one or more sections of the bimorph structure of a first copolymer sheet in the multilayer sheet to one or more copolymer sections of a second copolymer sheet in the multilayer sheet.

29. (canceled)

30. The method of claim 20, further comprising subjecting the one of more sections of the bimorph structure to deformation to create one or more pockets in response to exposure of the copolymer sheet to a temperature above a neutral temperature.

31. The method of claim 30, wherein the neutral temperature is about −20° C. to about 20° C.

32.-37. (canceled)

38. The method of claim 20, wherein the forming at least one copolymer sheet comprises forming a copolymer sheet comprising a first layer having a thickness of about 10 μm to about 1 mm and a second layer having a thickness of about 10 μm to about 1 mm.

39. (canceled)

40. The method of claim 20, wherein the copolymer sheet has a thickness of about 20 μm to about 2 mm.

41. The method of claim 20, wherein forming one or more sections of the bimorph structure in the copolymer sheet comprises forming one or more sections having a width of about 2 mm to about 20 mm and a thickness of about 20 μm to about 10 mm.

42. (canceled)

43. The method of claim 20, wherein the bonding comprises boding a first layer comprising a first polymer is selected from the group consisting of linear low density polyethylene, high density polyethylene, ultra-high molecular weight polyethylene, polyoxymethylene (Acetal), and Polyvinylidene fluoride (PVDF), to a second layer comprising a second polymer selected from the group consisting of polyethylene terephthalate, nylon, polycarbonate, polyether ether ketone (PEEK), polyimide, and polyetherimide.

43.-62. (canceled)
